(19) United States
(12) Patent Application Publication
(10) Pub. No.: US 2004/0253571 A1
(43) Pub. Date: Dec. 16, 2004

(54) Process and kit for the evaluation of leadership abilities

(76) Inventors: Pierre Jean Valayer, Rouen (FR); Clementine Aude Valayer, Waterloo (BE); Monique Valayer, Rouen (FR)

Correspondence Address: PIERRE JEAN VALAYER, 7 RUE D. LA CIGOGNI, ROUEN, 76000, FR

(21) Appl. No.: 10/859,108

(22) Filed: Jun. 3, 2004

(30) Foreign Application Priority Data
Jun. 13, 2003 (FR) 03 07125

(51) Int. Cl. G09B 19/00; A63F 3/00

(52) U.S. Cl. 434/219; 705/11

(57) ABSTRACT

To evaluate leadership abilities of individuals or teams in a competitive environment simulating the non-transitive character of interactions between three or more leadership competences, protagonists are caused to display their skills by competing to acquire vignettes or similar objects out of a kit of three or more categories respectively representing the three or more competences. Confrontations and negotiations are carried out according to accounting rules, which reflect the non-transitive dominance interaction between the respective leadership competences posted on the vignettes of each corresponding category. These rules include a confrontation differential between the values of vignettes of different categories. The process solves the problem of measuring leadership and dominance abilities in a competitive environment simulating the circular non transitive relationship which exists in human societies, for example, when the Knowledge based competence dominates the Politics based one, which dominates the Finance based one, which dominates the Knowledge based one.

### CROSS-REFERENCE TO RELATED APPLICATIONS

Foreign Application Priority benefits are claimed for French Application FR 03 07125, filed Jun. 13, 2003

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

001 The invention relates to a leadership evaluation process in the form of a behavioral test which simulates real life societal interactions, and which includes a kit that allows its execution. Furthermore, the invention relates to the evaluation of the performance of potential leaders in a highly competitive environment, and where the object of competition is the acquisition of a variety of assets. It relates also to the societal environment in which the potential leaders are evaluated, as well as to the dominance structure of the protagonists involved in such an environment.

002 The fields of endeavor to which this invention pertains are therefore: 1—the field of testing or grading a persons knowledge, skill, discipline, or mental or physical ability, including, among others, his/her behavioral characteristics, using, among others, means similar to playing cards, and: 2—the field of processes or apparatus for modeling to reproduce a non-electrical device or system to predict its performance (including evaluating human performance).

003 Uncovering early potential leaders has always been a vital aspect of the development of societies in all its aspects, sapient (i.e. scholarly knowledge, science, arts), political (including social and military) and financial (including industrial, commercial). Leaders have historically arisen naturally, and provide an inspirational track record of skills and drive. The ability to gain early access to- or predict individual leadership abilities is central to human resource development. Evaluation processes in the form of behavioral and/or psychometric tests have been developed for measuring leadership ability, including motivation, execution, ability to react to societal changes. In some, focus is placed on a leader's drive. For example, U.S. Pat. No. 6,007,340 to Morrel-Samuels plays a significant emphasis on a leader's personal conviction, in relating to his team, even by being visionary. In others, emphasis is focused on execution ability, such as complex problem solving, rather than motivation and drive. For example, WO 0 2075 697 to Fleishman et al, teaches a system and a method of assessing cognitive and meta-cognitive skills and leadership abilities used in the creative problem solving process central to leader effectiveness. In others yet, adaptability to face decisively new situations is emphasized. For example, U.S. Pat. No. 6,408,263 to Summers discloses a method for simulating changes in design opportunities to be used in management training.

004 Furthermore, leadership efficacy has to relate to the behavior of individuals who are facing different cultures or social groups, which are interacting together. Accordingly, systems which are designed to detect would-be leaders relate to specific contexts of society, albeit explicitly or implicitly. In the examples listed above, a (western culture style) business context is implicit, or even, at times, quite explicit, such as in U.S. Pat. No. 6,408,263 to Summers, as it relates to computer simulations that teach managers how to make better informed decisions, said computer simulation referring to business situations, business gaming and business war games. Further more still, “leadership” is implicitly perceived in this prior-art, as a “transitive” hierarchical relationship between individuals, in that “if A leads or dominates B, and if B leads or dominates C, then A, directly, or indirectly, leads or dominates C”: in the examples illustrated by those patents, skill attributes are scaled as a direct correlation with the leadership level of the individual, albeit within a given time of a transient situation as in U.S. Pat. No. 6,408,263 to Summers.

005 However, there is strong historical evidence, as described in details further, that human leadership does not respond to such a transitive model in our global society, which, furthermore, cannot be considered as a collection of sub-societies (e.g. business, political, and scholar, without prime consideration for their intransitive relationship), and the very different, at times opposite leadership attributes applicable to each sub-society. Leadership evaluation processes of the prior art, as illustrated above, do not recognize this situation, and may hence, unfortunately with a lot of conviction, encourage the appointment of an unsuitable person to the inappropriate position. Furthermore, these processes may not detect excellent potential leaders, particularly suited to the social environment where we are living, and which may be construed from historical evidence. Accordingly, and to overcome at least partially those defects, an intransitive society model has been developed and is described here after.

Intransitive Leadership Society Model (Specific Case: Circular and Three-Poled “Rock-Paper-Scissors” Model)

006 Contributing to correcting the frequent lack of relevance of society models that use (hierarchical) transitive relationships, the society model, which is at the basis for the present invention, represents a intransitive (as it happens, circular) dominance relationship between three powers, Politics, Finance and Knowledge; it arises from historical observations, where, globally, Knowledge dominates Politics, Politics dominates Finance and Finance dominates Knowledge, as illustrated in FIG. 1, where “K” signifies “Knowledge”, “P” signifies “Politics” and “F” signifies “Finance”. Such circular models are classically referred to as the rock-paper-scissors (RPS) model (Kerr B. et al., Ref 1).

007 This model, is based on the historical observation of “who needs whom” to survive in a competitive environment. The model is not transitive, because, if F>K, and K>P, it does not follow that F>P. The word “Knowledge” includes anything which is learned, whether science, literature, philosophy, scholarly knowledge, arts, etc. “Politics” includes “nation”, with its “territory”, its “military forces”. “Finance” includes “business”, “trading” and “industry”.

008 Historical observations are supportive of the model:

009 Control of Knowledge is essential to Politics, to the survival of a nation; if Politics does not have control of Knowledge, they will be overcome, hence their dependence on Knowledge. This is apparent in our modern society, where powerful nations are able to master their dominance through science driven weaponry. Even when applying immigration restrictions, nations do make key exception for people of knowledge; for instance, for the employment based immigrants into the US, preferences are to “priority workers”, i.e. persons of extraordinary ability, outstanding professors and researchers, and certain multi-national executives (US 2000 Census, Ref 2). Historically, great leaders kept abreast of the knowledge of their time, as Catherine the Great of Russia for the philosophers, Francis I, king of France, for the Renaissance (Web Encyclopedia, Ref 3).

010 Like-wise, access to Finance is essential to Knowledge. The modern-time science growth in the US is, at least partly, the result of the financing capacity of the Universities, Institutions and Corporations providing employment opportunities to the thousands of researchers seeking immigration into this country; in turn, this financing capacity, leading to adequate working conditions, is one of the prime motivation for researchers' “brain drain” (Brain-drain warning over UK lab facilities, Ref 4). Today's commercial and finance community places a high premium on proprietary Intellectual Property, accepting to invest essentially in research, which will earn financial returns (Michael Henos, Ref 5). The great sovereigns mentioned earlier have made sure that subsidies were available to the learned people they entertained in their courts. In their time, Arab and Berber traveling merchants got access to a variety of goods, which included gold and silver, which served as source of funds to their sponsors and rulers (History of West Africa, Ref 6); this further encouraged traveling learned people such as the philosopher Ibn Khaldun (Ref 7) and the geographer Ibn Battuta (Ref 8), who both described in detail the source of intellectual prosperity in the societies of their time. The rulers funded Universities and supported the scholars. The travelers brought a mass of information and writings back to the Universities, and their libraries. In turn, when this financial source dwindled, so did knowledge.

011 Finally, Finance itself can only thrive in “stable” political situations, as witnessed in today's credit rating of nations as provided, for example by Moody's Investors Services of New York City. Investors select politically supportive and stable nations for their projects. This is historically illustrated with the great Hanseatic leagues (Web Encyclopedia, Ref 9), who constituted politically safe havens with cities of the North Sea and the Baltic Sea, or with political organizations turned into financial guilds, such as the Order of the Templars (Web Encyclopedia, Ref 10).

012 However the direction of the interaction in the three poled model, i.e. the orientation of the domination may be changed, at least, for one of the arrows, when the sheer amount of power present at one of the poles increases beyond a certain threshold. For example, Politicians might become highly dependent from particularly rich bankers, as it was apparently the case for European governments with the Rothschild family after the Napoleonic wars (Web Encyclopedia, Ref 11).

013 Historical leaders are rarely been “universal”, in the sense that the predominant aspects of their respective characters can be associated with one of the three powers of our model. For instance, great politicians know how to take initiative in a conflict and could take decisions with resolve, even if such decisions imply the sacrifice of lives. They have absolute determination in combat situation, without necessarily being able to measure properly the risk they are taking against their own cause. Learned leaders are driven by their curiosity, without always realizing the risks of their undertaking, while business leaders, the good ones, excel in risk evaluation.

014 In this triad, allegiance to a group and to a leader is the result of the balance between the powers of money (Finance, trade), public force (Politics, military, nations) and Knowledge . . . This allegiance is also a function of the individual's perception of being able to contribute or get personally access to a share of one of those three categories of power. If he thinks any one of those is out of his reach, he might be afraid of it, try to destroy it, and pay allegiance to the leader who offers what is apparently within his reach.

015 An individual or a community, whether paying allegiance to one of the three power categories, or being its leader, might fear, hence like to destroy, a community paying allegiance to another power category. This, older and recent history is full of examples of the burning of books when the Politics felt threaten by Knowledge. Although it might not be as obvious whether Finance ever plotted any violent destruction of the power of Politics, this is an option which has been suggested in literary and movie production; for example, Oliver Stones movie “JFK”, (Oliver Stone, Ref 12). To illustrate the sporadic destructive attitude of Knowledge on Finance, one might mention the hostility of some philosophers against business and speculative finance, e.g. Karl Marx.

016 Alternatively, if a community (or an individual) believes in having the capability of genuinely acquiring power from another group, it will seek to do so, so as to extend its overall power. For example, immigration visa's favoring learned people (P→K), funding of political parties (F→P) and start-up business plans of the scientists addressed to capitalists (K→F) illustrate such reverse interaction between the three poles of the triad.

017 At any rate, each pole of the triad has a dominant skill, which cannot be fully transferred to people of another pole. Purchased weapons, however sophisticated, do not make a credible army in the hands of merchants. However hard they might have tried, very few Politicians' literary writings have survived the test of history, and an ideal chief scientific officer has seldom proven to be an acceptable chief executive officer of a start-up.

018 In this world competition for domination, two more features are determining factors: the nature of decisions, which might be tactical or strategic, and the role of public opinion shaped up by the media, changing the reality of events into a perception, which is usually the only remaining thing of relevance to future developments.

019 History is also teaching us that treachery is often mitigating and, at times, overwhelmingly modifying the course of events; covert interactions happen across the three categories of power, encouraging various forms of treachery. Business have used secret funds to bribe individuals or groups within an opponent's camp, Politicians make use of espionage agencies, and the learned people have a network of international contacts, of significant weight (what happened between Niels Bohr and Werner Heisenberg in Copenhagen during the war? As queried in Michael Frayn's play, Ref 13).

020 Finally, the course of historical events, frequently qualified as “fate”, has been, most of the time, “human driven fate”. Meteorological factors did occur at times, but human decisions (often “appearing” as casts of dice) were the triggers.

021 While existing leadership evaluation processes do not address the identification of leadership within such a society model, it is known that Games can be used in place of, or designed as, or modified into Leadership Evaluation Processes and/or psychometric tests. However, the review that follows [Prior art, as it might relate to societal model and dominance structure] illustrates the shortcomings in the attempts made by societal games to simulate leadership the society model described above; shortcomings also apparent in the “human laboratories” of the economists.

Prior Art, as It Might Relate to a Leadership Society Model

022 Intransitive (circular) dominance has been described in animal behaviorism, and stock exchange imbalances have also been extensively analyzed. However, the specific modeling of human society's circular relationship mentioned above has never been disclosed in a leadership evaluation process. [Note that such dominance based circular interaction is NOT the circular interaction as defined in Game Theory (Dixit et al. Ref 14), which is simply relating to protagonists who are thinking: “I think that he thinks that I think . . . etc”].

023 Intransitive (circular) dominance is known in the animal kingdom; statistical modeling of observations made in nature have been proposed, e.g. by J. Tufto et al. (Ref 15), as attempts to represent co-variance of observations in statistical equations. This circular domination is also known in simple (children) games; for example, two players compete using three different hand symbols: a fist (qualified “the Rock”), an open palm (qualified “the Paper”) and “V” shaped fingers (qualified “the Scissors”). At each round, the players thrust at the same time, from behind their back, one hand figuring one of the three symbols. The winner is according to the rule: “The Rock is dominated by the Paper (wrapped-up), the Paper is dominated by the Scissors (cut-up) and the Scissors are dominated by the Rock (smashed)”. This game is at the origin of the “RPS” model mentioned earlier. Some modern computer or consol games do make use of this circular feature, e.g. Chikyuu (Ref 16) referring to some figures in an electronic game comments: “Sentinel does well against storm, who does well against cable, who does well against sentinel”. However, neither such a circular dominance feature, nor the specific human society leadership circular relationship model described earlier, has ever been embodied into a global mechanism dominating a competitive leadership evaluation process. Furthermore, it has never been embodied as characteristic of the protagonists' personality, who single out the power of one of the poles of the circular relationship as presenting his/her personal affinity. In addition, no reference is made to such circular orientation of dominance being challengeable when the relative size or amount of the powers in presence is changed.

024 In fact games have often been used to simulate real world human interactions, relating to strategic domination, life, career and investment choices, stock exchange market fluctuations, businesses and diverse money dealings:

025 Thus, an association of abilities is nevertheless used in EP 0 167 546 to Tourville et al. describing a competitive dominance board game combining finance, military skills and strategy. However, in such game, no reference is made to the third important pole, “Knowledge”, or to any circular (i.e. more generally, non transitive) dominance interaction either. Global dominance games have been disclosed (e.g. U.S. Pat. No. 4,687,206 to Cordry et al.), which do, indeed reflect the “amount” of dominant power, e.g. territory, population, resources and technology, as well as strategic and tactical aspects, but, in such a case, they do not integrate the circular (i.e., more generally, non transitive) dominant orientation. Furthermore, such games limit, at least to some extent, the full responsibility of human decision, by means of introducing chance with an external tool (e.g. dice) for determining the outcome of at least some of the interactions; this limits the impact of the players' psychology by blurring his whims, instead of using those whims, unaltered, to drive the process and help, in this way, reveal more genuinely the leadership character of each player. Some games do, indeed, put emphasis on the psychology of players; for example a life choice game as disclosed in U.S. Pat. No. 6,267,375 to Bernstein et al. However, as in this patent, they are based on “multiple choices” of a preset menu of avenues of life, like a menu of a “user friendly” computer program. This is not a real freedom, allowing a protagonist to invent a personal strategy or a personal negotiation approach, especially if the game designer has not predicted his character profile. The character of a player itself might at times be categorized from a list, or, indirectly, through a set of indices out of a list of options, as disclosed in U.S. Pat. No. 4,216,971 to Like, but is not revealed by his/her actual behavior in the midst of his/her competitive interaction. Several games, within one field of skills, do highlight the protagonist's character in a competitive environment, but this is limited to the specific field, for example, the business, stock-exchange and money field, as in GB 2 195 088 to Lamb where the protagonists, by skill and dealing judgment and luck, contrive each to win the game by achieving ownership of most of the business, or GB 2 038 190 to Rodrigues where protagonists compete in a business game of (simulated) entrepreneurial and/or methodical skill.

026 Games have also been used to simulate covert activity, and “influence” activity:

027 Covert input of initial data of the register of a game has been used in U.S. Pat. No. 4,171,135 to Doyle et al.; however, this is done by a randomness source of writing data, not at the initiative of one of the protagonists plugging covert information in the initial data base of his/her opponent(s) so as to model treachery. Interference on human transaction by “influence” has been disclosed in the game modeling financial transactions as described in U.S. Pat. No. 5,803,456 to Lam introducing the players to the reality of the possibility that “politics” normally influence day to day transactions, however, this is a form of pre-set list of options laid out on the board; there is no reference to the “influence role” taken by an actual player on the decisions of the other protagonists by using means such as speech, stories, mimicking in this way the role of media.

028 Of all those games inspired by the simulation of real world human interactions, none globally associate Finance (business), Politics and Knowledge.

029 This limitation, which is found in the area of games, is also true in professional processes, like those used by economists to represent stock exchange mechanisms. Thus, V. Plerou et al (Ref 17), T. Lux et al (Ref 18) and R. Palmer (Ref 19) have singled out different categories of stock dealers, based on their behavior. In fact, a complete field of behavioral and experimental economics, in the form of human laboratories, has been given sound foundation by Daniel Kahnemen and Vernon Smith, Nobel Prize in Economics Science, 2002 (Ref 20), an area which more traditionally relied on field data. While those developments are most exciting and promising, it appears they have not yet integrated, nor even disclosed the possibility to evaluate the global association of business, politics and knowledge, in the sense we have described in the leadership society model above. Behavioral and experimental economics do avoid the use of chance/luck factor like dice or card shuffling, and, in fact rely exclusively on the whims of the human protagonists, which Kahnemen (Ref 20) has demonstrated, violate basic laws of probability. However, those experiments, while avoiding dice and using the variability of people, have the economics model as an end product objective, with people as input parameters, instead of: a society (tunable) model as an input, and the uncovering of people's character as an end-product.

030 In summary, neither existing leadership evaluation processes, nor games, nor the “human laboratory” of the economists take into account the competitive society model which is composed of the non transitive (circular) relationship between the powers of Politics, Finance and Knowledge, and which arises from historical observation, where, globally, Knowledge dominates or leads Politics, Politics dominates or leads Finance and Finance dominates or leads Knowledge. They do not either detect the kind of leadership, as it relates to the three categories of “Finance”, “Knowledge” and “Politics”. Of course, they do not address either the impact of such a model, on the other aspects such as the amount of the source of power used by a leader, the human decision (strategic or tactical) considered as the sole process mover in the evaluation of leadership, the covert activities, and the impact of medias. Yet, history does indeed support the relevance of such a model, and its ramifications.

031 Yet, history does indeed support the relevance of such a model, as well as a reliable leadership evaluation process based on such a model, and which would detect leadership talents early.

032 The following are citations of references identified in the above section. The entire disclosure of each referent is relied upon and incorporated by reference herein:

Ref 1: Kerr, B., Riley, M., Feldman, M. & Bohannan, B. (2002) “Local dispersal and interaction promote coexistence in a real life game of rock-paper-scissors.” Nature 418, 171-174

Ref 2: US 2000 Census. http://www.census.gov/prod/99pubs/99statab/sec01.pdf

Ref 3: Web Encyclopedia. “Francis I, The French renaissance.” http://www.encyclopedia.com

Ref 4: “Brain-drain warning over UK lab facilities.” Nature 391, 422 (1998)

Ref 5: Michael Henos. “Venture Capital and Intellectual Property.” The Atlanta Journal/The Atlanta Constitution. (Sunday, Oct. 24, 1993)

Ref 6: “History of West Africa.” http://www.khyber.demon.co.uk/history/naval_crusades/wafrica.htm

Ref 7: Ibn Khaldûn. “Al Muqaddima (French Translation: Discours sur l'histoire Universelle).” Acte Sud (1997)

Ref 8: Ibn Battuta. “Travels in Asia and Africa 1325-1354.” Routledge and Kegan Paul

Ref 9: Web Encyclopedia. “Hanseatic league.” http://www.encyclopedia.com

Ref 10: Web Encyclopedia. “Knights Templars.” http://www.encyclopedia.com

Ref 11: Web Encyclopedia. “Rothschild.” http://www.encyclopedia.com

Ref 12: Oliver Stone. “JFK” (Movie and book) Applause Theatre & Cinema Book Publishers

Ref 13: Michael Frayn. “Copenhagen.” Methuen Publishing Ltd

Ref 14: A. Dixit and B. Nalebuff (2002). “Game Theory.” http://www.econlib.org.

Ref 15: Tufto, J., E-J. Solberg, and T-H. Ringsby (1998) Statistical models of transitive and intransitive dominance structures. Animal Behaviour, 55:1489-1498

Ref 16: Chikyuu (2002). “Evolution 2002—MARVEL vs. CAPCOM 2 Report and Consideration.” Arcadia. http://www.shoryuken.com/features/e021112_{—}3.shtml (November 2002).

Ref 17: V. Plerou, P. Gopikrishnan and H. E. Stanley (2003). “Two-Phase behaviour of financial markets.” Nature. 421: 130.

Ref 18: T. Lux and M. Marchesi (1999). “Scaling and criticality in a stochastic multi-agent model of a financial market.” Nature. 397: 498-500.

Ref 19: R. Palmer, W. Arthur, J. Holland, B. Lebaron and P. Tayler (1994). “Artificial Economic Life—A Simple-Model of a Stockmarket.” Physica D. 75: 264-274.

Ref 20: “Advanced information on the Prize in Economic Sciences 2002, 17 Dec. 2002.” The Royal Swedish Academy of Sciences www.nobel.se/economics/laureates/2002/ecoad02.pdf

### BRIEF SUMMARY OF THE INVENTION

033 It is an object of the present invention to provide a behavioral test, including its enabling kit, and which can be effectively and repeatedly used as a reliable evaluation process to reveal leadership talents capable of performing in a competitive society based on the non transitive (circular) balance of powers described above.

034 At least three individuals (or teams) (the “protagonists”) compete to achieve global dominance by getting a hold of “assets” in a Circular Behavioral Test (the “CBT”) designed as a leadership evaluation process using a specifically designed kit (the “kit”) of vignettes or similar objects, including digital electronic images potentially used in net-works (the “vignettes”) representing said “assets”. Those assets, and, accordingly, the vignettes, which represent each un-dividable unit of asset, are characterized into three sets of different category: A, B and C, representing areas of leadership competency and personal inclination of the protagonists. The CBT is based on the relationship between the vignettes of different category A, B, C, which simulate the non-transitivity of certain relationship of leadership like the circular orientation of that is frequently found in natural competitive situations. This is illustrated in FIG. 2.

035 FIG. 1 described earlier corresponds to the example, where one observes that the power of Knowledge dominates the power of Politics, which dominates the power of Finance, which, in turn, dominates the power of Knowledge (A=K, B=P and C=F). Each category of asset—and their representative vignettes—can be further characterized into two types, representing areas of skill, e.g. S=Strategic and T=Tactical. For a proper execution of the CBT, and to avoid any misunderstanding between the protagonists, it is essential to use a kit where the vignettes bear a very clear materialization characterizing their respective category and type.

036 Before proceeding to a CBT, the evaluator selects direction of dominance between a unit of asset of a given category and/or type and a unit of asset of another category and/or type (which one dominates which one). By the same token, he also establishes the value ratios between strategic and tactical units within each category. This parameter setting (or calibration) of the CBT, based on the experience of the evaluator, allows to best represent the leadership impact of competencies and skills corresponding to the categories and types. For example, within one type, a given number of units of one category dominate the same number of units of another category according to the circular dominance model above, which is preferably recalled on each vignette. In this way, the CBT and its kit are compatible with the historical intransitive (circular) model illustrated earlier.

037 At the onset of the CBT, each protagonist (an individual or a team) competes to identify him/herself with a category, and to achieve its allocation. This enables him/her to collect vignettes of said category, while selecting their distribution according to the two types, and totaling a maximum value, identical for each protagonist. To stimulate the protagonists at this phase of the CBT, each vignette of the kit might display inspiring information concerning historical leaders who can be associated with each category and type, for example, their portrait, quotations, a very brief biography. At each round of the CBT, the protagonists interact among each other to transfer, destroy or swap each other's asset units represented by the vignettes, with the aim to get a hold of all the remaining units of the CBT. Two modes of interaction occur: confrontation or negotiation. In the case of confrontation, the winner can either destroy the opponent units or acquire them (simulating in this way human aggressive behaviors, balancing fear and greed). In the negotiation case, units are swapped according to whatever agreement is achieved between the protagonists, simulating in this way cooperative behavior.

038 The execution of the CBT with its kit of vignettes characterizing categories and types of leaders provides surprisingly discriminate, convincing and repeatable observations about the behavior of the protagonists, and their leadership and dominance ability, both in level and in kind (for example, a great financial leader, a little politician, etc.). Furthermore, the CBT allows measuring leadership and dominance abilities in a competitive environment simulating the circular non-transitive relationship, which exists in human societies.

### DESCRIPTION OF THE DRAWINGS AND FIGURES

FIG. 1: Circular dominance relationship between Knowledge (K), Politics (P) and Finance (F)

FIG. 2: Circular dominance relationship between three categories A, B and C., representing areas of leadership competences.

FIG. 3: Schematic extract of an example of vignette kit, where one vignette for each category and type is represented, front and back views, from top to bottom, the categories “Knowledge”, “Finance” and “Politics”, and, on the left side, each type: “Strategic” and “Tactical”.

FIG. 4: Embodiment of capitals of assets at the onset of a CBT, as they have been materialized by each protagonist, who laid out their vignettes, which they selected from the kit of categories and types.

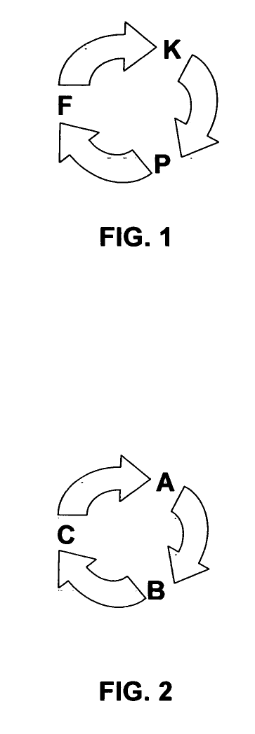

### DETAILED DESCRIPTION OF THE INVENTION

039 An object of the present invention, the CBT with the kit specifically designed to ensure its effectiveness, is to simulate real life human competitive interactions, which include a non transitive (circular) relation of dominance. A further object of the present invention is to discover the most revealing leadership aspects of the character of each individual under evaluation, in a competing environment similar that which happens in human societies and which includes a non transitive (circular) relation of dominance. While functioning a bit in the way of children who are testing their own leadership potential in a school playground, the CBT with its kit is unique in that its characteristics and operating process, described further, allow the simulation of actual society interactions such those occurring between the powers of Politics, Finance and Knowledge: it is used professionally like human laboratories in the field of behavioral and experimental economics, but with industrial applications like psychometric tests in human resource recruitment and development.

040 Accordingly, the CBT models a particular aspect of human interaction, whereby powers, who are competing to capture the “assets” of life, dominate each other in a circular way, resulting into difficult-to-predict outcomes. Chance or luck does not enter this CBT other than by the whim of each individual. Yet, as in real society, such whim creates a great variety of situations, not necessarily abiding to classical laws of probability. The protagonists have no other attribute than their urge, their character, and, as assets, what they make out of the capital they receive at the onset of the CBT, mimicking, in this way, what one does with one's own education and inherited estate. However, as in social competition, each one tries to protect or to increase his/her capital of assets and to come out victorious by acquiring most or all available assets. In fact, the CBT uses procedures essentially driven by human nature—and by the experience acquired during a given session.

041 Preferably, an initial capital of “assets”, representing wealth or attributes, is allocated to the protagonists at the beginning of a CBT according to agreements from which examples are quoted further. This is preferably done with the kit of vignettes, representing such assets. A CBT is executed between teams or between individuals, in competition to acquire all the “assets” of the opponents. It finishes either when all the assets have fallen in the hands of a single protagonist (or team) or by a preferably unanimous decision to stop the CBT, in which case the winner is the protagonist or the team which will have booked the highest total of asset units.

042 In the course of the execution of a TCC, the relative leadership character of each protagonist becomes very apparent to both the protagonists and the onlookers, as he/she succeeds or not in his/her endeavor, in the leadership category he/she has selected, and as his/her opponents (or teamster) follow or oppose his/her actions.

043 In a preferred embodiment, the CBT has six characteristics, which, taken together, are representative of real life situations. They embody typical life/society situations, fully driven by the collection of protagonists, but where causal factors are not straight forward, including multiple factor feed-back loops, long-term or strategic dominance, as well as short term tactical ones, diversity of behavior, at times overt, at times covert. As we shall see in the example developed in detail further, the CBT and its kit can be tailored to represent concrete and real situations, thanks to those six characteristics, which are listed below:

044 There is no other luck or chance than what could be generated by the behavior of the protagonists; hence, no dices are to be used in the CBT.

045 Assets, in the form of “units” materialized by the vignettes selected from the kit, for example in totally free negotiations between two protagonists (or two teams), or by confrontation between units or groups of units of assets belonging to the confronting protagonists (or teams). In the latter case, loosing assets can alternatively be destroyed (taken out of the CBT). These exchanges, acquisitions or destructions can also be made between alliances of protagonists (temporary or permanent allies), for example, protagonist 1 and 2 can negotiate an alliance to confront protagonist 3, for one or several operations or, even, for the complete duration of a CBT.

046 Assets are constituted by a collection of units of different categories, which are materialized by the vignettes. One category out of three A, B, C, with the possibility to use more categories, must be made distinct by an agreed symbol, or a spelled out text on each vignette. Each unit is assigned a confrontation worth at the beginning of the CBT, in a way such as that described in the next paragraph, so as to resolve the outcome of the confrontations, while recognizing the circular nature of their relative worth (unit A “dominates” unit B, which, itself “dominates” unit C, which, itself “dominates” unit A, such relation being preferably reminded, for example by a text, on each vignette).

047 Within each category, the assets are divided into two types also symbolized on the vignettes which are their material representation, for example as “strategic” and “tactical”, with the value of a unit of one type having the value of a multiple of units of the other type. For example, a “strategic” unit can be worth 10 “tactical” units. To make this practical, it will be useful to establish an accounting and scoring procedure. For example, one might find it convenient to make use of a “Tactical Equivalent Unit”, or TEU. In our example, 1 strategic unit=10 TEU, 1 tactical unit=1 TEU. For a smooth progression of the CBT, it will be convenient that the vignettes, which represent the units of asset, be assigned clearly their corresponding TEU number. Furthermore, during a confrontation between a strategic unit of a given category and its equivalent in tactical units of whatever other category, one can agree that the “Strategic” will always “dominate” the “Tactical”. It will also be necessary to agree at the beginning of the CBT on a “confrontation differential” (CD) which will determine the size at which an asset of one category cancels out the domination it normally submits to, in the circular balance of powers of the CBT. In our TEU accounting example, if one chooses CD=2, an asset unit (or group of units) of category A having a TEU=10 will dominate an asset unit (or group of units) of category B having a TEU=10 or 11, but not 12.

048 Initiative remains the essential driver of the CBT: for example, during the allocation of assets at the beginning of a CBT, each protagonist is free to organize the distribution of his/her units in “tactical” and “strategic” as he/she sees fit; it is not necessary to establish any rule for the attribution of a turn to each protagonist: one can agree that the turn is awarded to the protagonist (or to the team) who manages to impose him/herself or to be convinced

049 Each asset category is assigned “characteristics” symbolized or spelled out on the vignettes which are their material representation, allowing each protagonist to distinguish him/herself in an essential and characteristic way with regard to the other protagonists, by having an ownership preference for one of the categories of assets because of one or several characteristics or attribute of this asset. For example, if a category of assets is characterized by a strength which a protagonist would like to own, such as “fighting, i.e. conflict management”, and that the accounting rule of the CBT rewards the protagonist effectively using such strength, the protagonist might like to try anything to acquire this category at the beginning of the CBT. If successful, he/she shall be awarded the capital of assets of the category of his/her choice. Otherwise, the protagonist may have to be content with a second or third choice. One can also, and preferably, agree of a privileged treatment granted to each protagonist when he/she uses, during any round of the CBT, one of his/her assets thus awarded; for example, one can agree that the value of his/her privileged asset is bigger when in his/her control than when it falls in the hands of another protagonist. This is a way to represent the personal characteristics of competitiveness of each protagonist with regard to the others. An important characteristic of the CBT is to give each protagonist, as much as possible, the initiative of the choice of his/her asset category. However, a variant where the allocation of the categories is made otherwise is possible: in particular, if one wants to CBT such or such specific talent of such or such protagonist.

050 The law and order of the CBT can be enforced by agreeing additional rules, at the beginning or in the course of the CBT: for example the relative value of units, the confrontation differential, and the way confrontations are resolved. In this last case, one can agree for example, that the asset, when “victorious” of a round, is “taken out of action” for an agreed period, so as to avoid that the same unit can de facto work as if it were a multiple of its own value.

Variants

051 The basic CBT can be expanded by the addition of one or several supplements described below:

052 Supplement 1: Each category enjoys a special attribute of covert activity (this variant is a preferred embodiment).

053 Supplement 2: Introduction of a protagonist of influence (the “media”).

054 Supplement 3: CBT in teams.

Example of the Variant “Knowledge”, “Finance” and “Politics” with or without Addition of the Supplement of Influence with a Protagonist Representing the “Media”, and with or without Addition of the Supplement “Teams”.

055 The Category “Knowledge” illustrates everything that is intellectual, scientific, literary, philosophical or artistic. Knowledge dominates politics, but submits to Finance. Knowledge is characterized by an efficient curiosity and a taste for the unknown. Knowledge receives fees for any special attribute action, who-ever the author. Knowledge's specific attribute is its network of contacts, allowing its covert control of certain opponents' assets.

056 The Category “Finance” illustrates everything that relates to trading, whether this is money, transportation, means of production or marketing, or even the engineering, which allows developing products and factories. Finance dominates Knowledge but submits to Politics. A taste for risk, and a talent for measuring the later characterize finance. Finance receives an interest on any negotiation that reaches a conclusion. The specific attribute of Finance is its secret funds, allowing it to covertly control some of its opponents' assets.

057 The Category “Politics” illustrates everything that concerns the State, in particular the territory, the nationality, the law and order and especially, the military power. Politics dominates Finance, but submits to Knowledge. Politics has absolute determination in combat and has a privileged ownership of conflicts. Politics is not punished during a conflict but receives a levy from any winner of a confrontation. The specific attribute of Politics is its espionage agency, allowing it to organize treachery within opponents.

Example of the Variant “Knowledge”, “Finance” and “Politics” Including, in Addition, the Existence of a Covert Activity, Designated: “Special Attribute”.

058 Each protagonist who's original asset category is respectively “Knowledge”, “Finance” and “Politics”, is awarded a number of TEU of asset which he/she can select within the category(-ies) normally the property of one or the other opponent (or in both, according to its choice). For example, one agrees at the beginning of the CBT, that 20 TEU are so awarded to each protagonist.

059 Let us take the case of the protagonist with the category “Knowledge”, who might secretly select 16 TEU of assets belonging to “Finance” and 4 TEU of assets belonging to “Politics”. This selection will be further distributed between the strategic and tactical types of assets of the targeted opponents, then, still in secret, documented in writing. It will follow that certain assets, within “Finance” and “Politics” will, in reality, be under the control of “Knowledge”. In the case of “Knowledge”, the special attribute is its capacity of contacts with learned people. The friends of Knowledge are in fact everywhere. In the case of Finance, the special attribute is covert financing, secret funds, allowing to bribe such or such, ensuring his/her reliance, even abroad. As for Politics, it organizes its own ring of spies and moles.

060 In this manner, these special attributes represent the unreliability of the affairs of this world. We shall see further how this unreliability shows itself during the progress of the CBT. In fact, the special attribute transfers, in a covert way, the property of an asset.

Example of the Variant “Knowledge”, “Finance” and “Politics”, Including, in Addition, the Protagonist of Influence Representing the “Media”.

061 The Category “Media” illustrates everything which relates to the communication of presumed facts or reality, invented, falsified or exact and informed, and which can influence the course of events. The media have access to the whole information, public, occult or secret. They communicate what they want, as it is, modified or completely disguised and falsified. They can also communicate nothing at all. The media are characterized by their capacity to replace the reality by a fiction, which protagonists might eventually consider as a reality, or not. The Media generate their satisfaction by the influence that they exercise on the decisions of the protagonists by means of information broadcasting.

Example of the Variant “Knowledge”, “Finance” and “Politics”, Including Protagonist Teams Instead of Protagonist Individuals.

062 Instead of one individual per protagonist, there are several, grouped into teams, which become the actual protagonists. Each team appoints a leader, who, in turn appoints each team member to a function consistent with his/her respective talent. Each leader also defines the delegation rules within his/her team. For example, such or such member of the team is assigned the management of such or such asset. Or still, such member of the team is assigned the negotiation job, if such is his/her particular talent.

063 The sub-distribution within each team can possibly be made by individual choice by the same process as during the main selection of categories of assets.

064 An example of teams is illustrated in the following table I :

TABLE I

| Politics | Finance | Knowledge |
|---|---|---|
| Territory, | Finance | Engineers |
| Resources | | |
| Soldiers | Transport | Physicists |
| Infrastructure | Factories | Biologists |
| Spies | Commercial | Writers, |
| | | Journalists |
| | | Philosophers |
| War lords | Laborers | Laboratories, |
| | | Libraries |

CBT Progression:

Step 1/ Establishment of a Practical Definition for Each Category:

065 This step shapes up the respective characteristic(s), which shall differentiate the categories from the one-another, as well as their special attribute(s), with the objective to achieve a CBT, which is both stimulating and inspiring for each protagonist, and to agree on an accounting Process for the assets.

066 Hence, in the example Knowledge-Finance-Politics, the characteristics, the specific attributes and the resulting accounting rules could have been agreed (still as example) as it is illustrated higher and collected in the following table II.

TABLE II

| | | Submits | | Special |
|---|---|---|---|---|
| Category | Dominates | to | Characteristics | Attribute |
| Knowledge | Politics | Finance | Effective | Network of |
| | | | curiosity and | contacts of |
| | | | taste for the | learned |
| | | | unknown. | people |
| | | | | (allowing the |
| | | | | covert |
| | | | | control |
| | | | | of certain |
| | | | | opponents' |
| | | | | assets). |
| Finance | Knowledge | Politics | Taste and | Secret funds |
| | | | capacity for | (allowing the |
| | | | risk | covert |
| | | | evaluation. | control of |
| | | | | certain |
| | | | | opponents' |
| | | | | assets). |
| Politics | Finance | Knowledge | Absolute | Espionage |
| | | | determination | agency, |
| | | | in combat and | allowing the |
| | | | privileged | organization |
| | | | ownership of | of treachery |
| | | | conflicts | within |
| | | | | opponents. |

067 After the original allocation of the total value of assets to each protagonist (e.g. 100 TEU), one can agree on an accounting Process as in the following table III, which can be modified from session to session to adjust its impact according to the desired emphasis on the outcome of the CBT, e.g. the duration of a session (how fast can a CBT reach completion), the contrast amplification between protagonists, the set-up of handicaps; for example, while using the same categories as above, it will nevertheless be possible to choose different TEU distributions at the beginning of any CBT session. Likewise, an accounting Process, perfectly adequate for a given set of categories (e.g. Politics/Knowledge/Finance) might have to be adjusted for another set, which one might imagine or select.

068 In the specific example illustrated in Table III below, the protagonists agree to recognize that an asset of a given category has more value when in the hands of an owner of the same category (i.e. the original owner), than otherwise.

TABLE III

| Unit of | Strategic | | Tactical | |
|---|---|---|---|---|
| asset | Original or | | Original or | |
| (TEU) | recovered | Acquired | recovered | Acquired |
| Value | 10 | 5 | 2 | 1 |

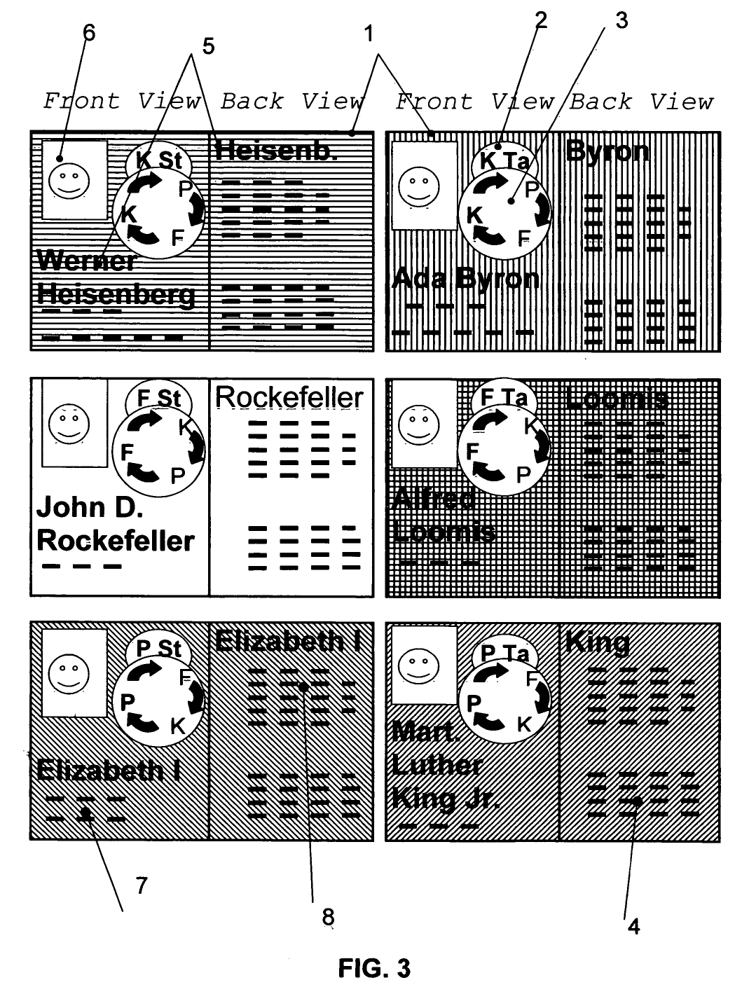

069 Furthermore, the accounting mechanism, in the course of the CBT, is made tangible by the allocation of vignettes, each one representing a tactical or a strategic asset of an agreed value. Those vignettes establish the tangible stakes of a CBT; they change hands according to the rounds within the CBT, as protagonists win assets at the expense of others. An example of a set of vignettes is illustrated in FIG. 3,further explained in paragraph 076; it consists of a “kit”, because each category and each type within each category must be specifically represented on the vignettes, which, therefore, characterize them. One will also represent the “size” of the assets within one category and type by multiplying the number of vignettes within this category and type, i.e. one vignette per asset unit.

070 In the case of the variant which includes special attributes, the occult/secret accounting starts with an initial total number of TEU allocated to each protagonist, who then documents secretly how he/she distributes the assets of this allocation in a table similar to Table IV (for example, in the form of “sticks” which can be scored off as they are used up in the progression of the CBT, as illustrated in the same table completed as in Table VII).

TABLE IV
Category: Covert TEU awarded:

| | | Strategic | | Tactical | |
|---|---|---|---|---|---|
| | TEU | assets | | assets | |
| Opponent | distribution | Number | TEU | Number | TEU |

071 The following table V illustrates taxes, levies and interests collected during the rounds of a CBT session, which will be detailed further. Payments are made in the form of asset units transferred, according to their agreed TEU number.

TABLE V

| Levies, | | | | Special |
|---|---|---|---|---|
| fees, and | Conflict | | | action |
| interests | Winner | Looser | Negotiation | (covert) |
| Knowledge | Pays Politics | Free | Pays Finance | Free |
| | a levy of 2 | | an interest | |
| | TEU. | | of 2 TEU | |
| Finance | Pays Politics | Free | Free | Pays |
| | a levy of 2 | | | Knowledge a |
| | TEU | | | fee of 2 TEU |
| Politics | Free | Free | Pays Finance | Pays |
| | | | an interest | Knowledge a |
| | | | of 2 TEU | fee of 2 TEU |

072 The protagonists can unanimously agree to modulate the values chosen according to the desired impact.

073 During this period, if the variant “Media” is included in the CBT, the protagonist labeled “Media” takes privately note of all the assets, including the secret ones, which each other protagonist must disclose to him/her.

Step 2/ Creation of the Identity of the Protagonists.

074 As in a school playground, the protagonists negotiate a dominant identity, relative to each other. While not disclosing the reason of their choice, it is preferred that they make their selection as much from a vocation view point (in the chosen example: Knowledge, Finance or Politics [+Media, in the CBT in 4]) as from a character perspective (e.g. audacious or careful, tactician or strategist, chivalrous or sneaky).

2a/ To Uncover One's Ambition for a Vocation.

075 At first, each protagonist has to define for him/her-self which category he/she wishes to choose, and to convince him/her=self of what he/she really wants. In support, one can take inspiration from anywhere. In the example Knowledge-Finance-Politics, one can get inspiration from the characteristics of the CBT illustrated in the previous tables. For example, one might consider one=self more effective in the category of Politics, with its conflict emphasis (absolute determination in combat), than in the category of Finance, with its negotiation emphasis (taste and capacity for risk evaluation) or than in the category of Knowledge, with its dominant of occult actions (effective curiosity and taste for the unknown). One can also simply be inspired by the life and the words of personalities who became famous in any given category.

076 The vignettes mentioned earlier and intended to represent different tactical and strategic assets, can contain notes, which can be used as source of inspiration as illustrated in FIG. 3, and in the text content of a vignette example described further (079). A kit of six vignettes is represented in FIG. 3, one vignette for each three categories from top to bottom: “Knowledge”, “Finance” and “Politics”, and, within each category, “Strategic” on the left and “Tactical”, on the right. For each vignette, both its front and backside are shown. “Categories” and “Types” are characterized by the color of each vignette, represented on FIG. 3 by hatches (1), and formally confirmed by a symbol (2) (or by a text) on the front side of each vignette. The circular relationship is also reminded on the front (3).

077 On the backside, the specific conventions applying to the assets represented by the vignettes are also spelled out (4), as shall be shown further (00079), in the example of the text content of a vignette. Each vignette can be supplemented by the illustration of an inspiring historical or recent leader (5), with a small portrait (6) and a few quotations (7) on the front side and a very short biography on the backside (8)

078 For each vignette category and type, the protagonists can be offered a selection of prepared vignettes, each referring to a different leader illustrative of the category and type considered, with, on the front side, a picture of the leader and examples of some of his inspirational citations, and, on the back side, a short biography. One can also use sets of color as a background of each vignette, conventionally characteristic of its category and type. Any protagonist can also make up his/her own vignettes, provided he/she sticks to the agreed convention of representation of category, type and conventions; i.e. he/she can take inspiration from a leader outside the set offered by the organizers of the CBT.

079 The text content of the example of a vignette is illustrated hereafter:

On the Front-Side:

Strategic Knowledge

Werner Karl Heisenberg

“The object of Research is no longer Nature in itself, but rather, Nature submitted to the human questioning, and, within this framework, man encounters, here, only himself.”

“It is only reasonable to include in a theory, solely observable quantities.”

On the Back-Side:

Werner Karl Heisenberg

Father of the quantum mechanics theory, based on what can be observed, hence, on the radiations produced by atoms in a discontinuous way. Hence, position and movements of particles modeled by matrix equations, reducing physical quantities into distinct elements corresponding to possible transitions within the quantum theory atom. Heisenberg's uncertainty principle on position & momentum. Fruitless effort with Nazi 's on atom bomb

Knowledge dominates Politics but submits to Finance.

Knowledge is characterized by an efficient curiosity and a taste for the unknown.

Knowledge receives fees for any special attribute action, who-ever the author

Knowledge's specific attribute is its network of contacts, allowing its covert control of certain opponents' assets.

2b/ Each Protagonist to Establish a Vocation.

080 Each protagonist tries to convince the others of the merits of his/her choice for a category, or to assert him/her=self somehow, as in life, to end=up with a role distribution by consensus. The utilization of dice, or other chance derived means for the resolution of a situation, should be avoided in the CBT, even at this stage. Leadership characters reveal themselves in such consensus resolution processes.

2c/ To Build Up One's Character so as to Defend One's Vocation.

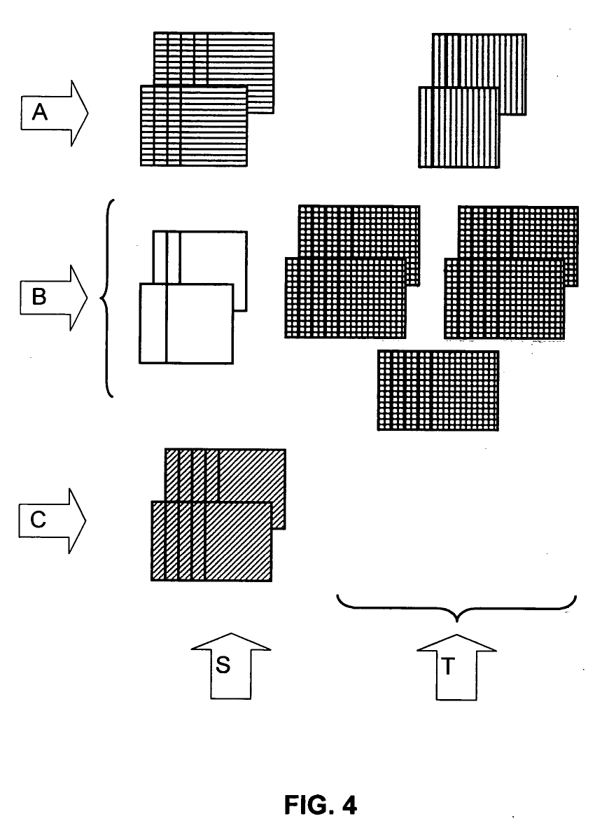

081 An expression of one's character is displayed by the way one structures one's original capital of assets at the beginning of the CBT. In the chosen example, each protagonist is entitled to 100 TEU and structures this capital as he/she sees fit. Table VI below gives an example of such a distribution and FIG. 4 illustrates a “vignette” based materialization of this distribution. Such layout prepared by each protagonist will start revealing his/her character. This distribution is consistent with Table III.

TABLE VI

| | | Protagonists' original distribution | | | |
|---|---|---|---|---|---|
| | Original | choice | | | |
| | TEU | Strategic assets | | Tactical assets | |
| Category | allocation | Number | TEU | Number | TEU |
| Knowledge | 100 | 9 | 90 | 5 | 10 |
| Finance | 100 | 5 | 50 | 25 | 50 |
| Politics | 100 | 10 | 100 | 0 | 0 |

082 As illustrated in FIG. 4, which is consistent with Table VI, this distribution materializes in the selection of vignettes from the kit, in this example: with 9 “Strategic” vignettes (S) et 5 “Tactical” vignettes (T) from the “Knowledge” category (A), with 5 “Strategic” vignettes (S) et 25 “Tactical” vignettes ) from the “Finance” category (B) and 10 “Strategic” vignettes (S) from the category “Politics” (C).

083 However, out of the 100 TEU allocated to any given protagonist, 20 at most (or another number to be agreed at the beginning of the CBT) can be treacherous, in the sense that they are under the control of one or both of the other protagonists. Indeed, as soon as the official distribution of the assets of each one is known, each protagonist secretly chooses a 20 TEU worth of tactical and/or strategic asset distribution among the list of assets of his/her opponents.

084 He/she takes note of this acquisition, in secret and before starting the CBT rounds, on a piece of paper e.g. on the index card illustrated earlier in Table IV, and reproduced here, completed with an example, in Table VII.

TABLE VII
Category: Knowledge Covert TEU awarded: 20

| | | Strategic assets | | Tactical assets | |
|---|---|---|---|---|---|
| | TEU | | TEU | | TEU |
| Opponent | distribution | Number | Value | Number | Value |
| Finance | 16 | / | 10 | / / / | 6 |
| Politics | 4 | — | — | / / | 4 |

085 These treacherous assets remain, in this way, occult, in the sense that their effective distribution is unknown to their formal owner. The actual unreliability of a treacherous asset will appear in broad daylight as soon as a protagonist uses it, since, at such time, the protagonist who actually controls it has the option to declare the real allegiance of this asset. By such a declaration, the asset so discovered works in favor of the one who has it under actual control, and not in favor of the one who owns it formally. An illustration will be given further. Naturally, each time a treacherous asset is revealed, the capital “special attributes occult TEU” decreases by the value of the revealed treacherous asset.

Step 3/ Progression of the Interactions between the Protagonists.

3a/ Taking the Lead of a Round

086 In this CBT, initiative must be rewarded. The initiation of a round is awarded to the first one who actually takes the lead by making the first step of this round. However, to recognize that, in real life, keeping the upper-hand at all times might be tiring—or even exhausting—in the long run, one can agree at the beginning of the CBT that each protagonist cannot initiate more than one, (or two or three, etc.) rounds in a row.

3b/ Hostile Interaction (Confrontation)

087 The aggressor designates the weapon (one or some of his/her assets) and the target of the attacked (one or some of the asset units of an opponent) by following the orientation of precedence resulting from the tables of accounting as illustrated earlier (Tables II and III), and the outcome of the fight is in his/her favor, with two exceptions:

a/ when the attacked counter-attacks with an asset capable of dominating the asset of the aggressor, with the proviso of possessing a counter-attack reserve in this category, larger than the reserve of the attacker [according to the way one wants to represent the inherent advantage of being the first to attack, one might agree a different convention, for example: “provided that the attacked possesses, in the considered category, a reserve of assets twice the amount needed to mount the counter-attack”] or:

b/ when the attacked reveals that the attacking asset was really a treacherous asset, under the actual control of the attacked (exception “b” when one plays the variant 1 of the CBT); in that case, the attacking asset is simply transferred to the camp of the attacked, who deducts its value from the secret amount logged on Table IV and the payment of levies, fees, and interests is made according to established tables as the examples of Table V. In the general case (without occult activity), the outcome of a hostile interaction transfers the asset of the vanquished to the camp of the winner (or destroys it, by taking it out of the CBT, according to the winner's choice). However, to represent the service costs and the need to regenerate the fighting forces and to repair the assets in the aftermath of a combat, agreed payments will be made as illustrated in Table V and the assets which have just been engaged in a combat will have to wait for one (or two or three) rounds, before being available again for action, according to what the protagonists will have agreed at the beginning of the CBT.

3c/ Interaction by Negotiation.

088 Concerning transfers of assets between negotiating parties, anything is allowed, because anything can be negotiated, as long as the negotiating parties agree, plus or minus the agreed mentioned interests as illustrated in Table V.

### EXAMPLE (1)

### Of Execution of a CBT in Its Preferred Mode

Step 1:

089 Werner, Elizabeth and Nicole agree to execute a “Knowledge/Finance/Politics” CBT. They also agree on the value of units as per table VIII:.

TABLE VIII

| Unit of | Strategic | | Tactical | |
|---|---|---|---|---|
| asset | Original or | | Original or | |
| (TEU) | recovered | Acquired | recovered | Acquired |
| Value | 10 | 5 | 2 | 1 |

Step 2a:

090 Time for personal reflection.

Step 2b:

TABLE IX

| | Protagonist(s) | |
|---|---|---|
| Sequence | intervention | Argument/Action |
| 1 | Nicole | Declares she wants to be a |
| | | “Finance” leader. |
| 2 | Elizabeth | Declares she wants to be a |
| | | “Knowledge” leader. |
| 3 | Werner/Elizabeth | Argue, as both want to be |
| | | “Knowledge” leaders. |
| 4 | Werner/Elizabeth | Argument settles on Werner = |
| | | “Knowledge” leader and |
| | | Elizabeth = “Politics” leader. |

Step 2c:

091 The protagonists elect to organize their point distribution as in table X.

TABLE X

| | | | Protagonists' original | | | |
|---|---|---|---|---|---|---|
| | | | distribution choice | | | |
| | | Original | Strategic | | Tactical | |
| | | TEU | assets | | assets | |
| Protagonist | Category | allocation | Number | TEU | Number | TEU |
| Werner | Knowledge | 100 | 9 | 90 | 5 | 10 |
| Nicole | Finance | 100 | 5 | 50 | 25 | 50 |
| Elizabeth | Politics | 100 | 10 | 100 | 0 | 0 |

092 . . . and their covert points are recorded on three tables XI (a, b and c) that they keep concealed from their opponents, while updating this record by scoring off their covert assets as they are being used up.

TABLE XI
a, b and c

| | | Strategic units | | Tactical units | |
|---|---|---|---|---|---|
| | TEU | | Value | | Value |
| Opponent | distribution | Number | TEU | Number | TEU |

a
Category: Werner (Knowledge) Covert TEU awarded: 20

| | | | | | |
|---|---|---|---|---|---|
| Nicole = | 16 | / | 10 | / / / | 6 |
| Finance | | | | | |
| Elizabeth- | 4 | | | / / | 4 |
| Politics | | | | | |

b
Category: Nicole (Finance) Covert TEU awarded: 20

| | | | |
|---|---|---|---|
| Werner- | 0 | | |
| Knowledge | | | |
| Elizabeth- | 20 | / / | 20 |
| Politics | | | |

c
Category: Elizabeth (Politics) Covert TEU awarded: 20

| | | | | | |
|---|---|---|---|---|---|
| Nicole- | 10 | / | 10 | | |
| Finance | | | | | |
| Werner- | 10 | / | | / / / / / | 10 |
| Knowledge | | | | | |

Step 3: CBT Progression (Comments at the Bottom of the Table)

TABLE XII

| | Activity | | | | Asset record | | | | |
|---|---|---|---|---|---|---|---|---|---|
| Rnd | Neg | Confront | | Outc & | Assets | | Werner. | Nicole | Elizab. |
| Ini | Opng | Opng | Def | Fees | Category | Type | (Knw) | (Fin) | (Pol) |
| 0 | | | | | Knowledge | Stra. | 9 | | |
| | | | | | | Tact. | 5 | | |
| | | | | | Finance | Stra. | | 5 | |
| | | | | | | Tact. | | 25 | |
| | | | | | Polit. | Stra. | | | 10 |
| | | | | | | Tact. | | | |
| | | | | | Covert TEU | | 20 | 20 | 20 |
| 1 | 1F: N | | | 1F: N->E | Knowledge | Stra. | 9 | | |
| Nicole | | | | | | Tact. | 5 | | |
| | 1P: E | | | 1P: E->N | Finance | Stra. | | 4 | 1 |
| | | | | | | Tact. | | 23 | 2 |
| | | | | 2f: N->E | Polit. | Stra. | | 1 | 9 |
| | | | | | | Tact. | | | |
| | | | | | Covert TEU | | 20 | 20 | 20 |
| 2 | | 1F: N | 1F: N | 2F: N->N | Knowledge | Stra. | 7 | [2] | |
| Nicole | | | | | Tact. | 5 | | | |
| | | 1S: W | 2S: W | 2S: W->N | Finance | Stra. | | 2 + [2] | 1 |
| | | | | | | Tact. | | 21 | 4 |
| | | | | 2f: N->E | Polit. | Stra. | | | 9 |
| | | | | | | Tact. | | | |
| | | | | | Covert TEU | | 20 | 20 | 20 |
| 3 | | 1S: W | 1S: W | 4S: W->W | Knowledge | Stra. | 3 + [4] | 2 | |
| Werner | | | | | | Tact. | 3 | | 2 |
| | | 1P: E | 4P: E | 4P: E->W | Finance | Stra. | | 4 | 1 |
| | | | | | | Tact. | | 21 | 4 |
| | | | | 2s: W->E | Polit. | Stra. | [4] | | 5 |
| | | | | | | Tact. | | | |
| | | | | | Covert TEU | | 20 | 20 | 20 |
| 4 | | 2P: E | 2P: E | 2P: E->N | Knowledge | Stra. | 7 | 2 | |
| Elizab. | | | | | | Tact. | 5 | | 0 |
| | | 2F: N | Secret | 2F: N->N | Finance | Stra. | | 4 | 1 |
| | | | | | | Tact. | | 21 | 4 |
| | | | | 2s: E->W | Polit. | Stra. | 4 | 2 | 3 |
| | | | | | | Tact. | | | |
| | | | | | Covert TEU | | 20 | 0 | 20 |
| 5 | 1P: E | | | 1P: E->N | Knowledge | Stra. | 7 | 2 | |
| Elizab. | | | | | | Tact. | 5 | | |
| | 12f: N | | | 5f: N->E | Finance | Stra. | | 4 | 1 |
| | | | | | | Tact. | | 16 | 9 |
| | | | | | Polit. | Stra. | 4 | 3 | 2 |
| | | | | | | Tact. | | | |
| | | | | | Covert TEU | | 20 | | 20 |
| 6 | | 3F + 3f: N | | 3F + 3f: N->N | Knowledge | Stra. | 7 | 2 | |
| Nicole | | | | | | Tact. | 5 | | |
| | | 2P + 2f: E | | 2P: E->N | Finance | Stra. | | 1 + [3] | 1 |
| | | | | | | Tact. | | 11 + [5] | 9 |
| | | | | 2f: E->N | Polit. | Stra. | 4 | 3 + [2] | 0 |
| | | | | | | Tact. | | | |
| | | | | | Covert TEU | | 20 | | 20 |
| 7 | 7f: E | | | Merger | Knowledge | Stra. | 7 | 2 | |
| Elizab | | | | | | Tact. | 5 | | |
| | 1P: W | | | 7f: E->W | Finance | Stra. | 1 | 4 | 0 |
| | | | | | | Tact. | 7 | 18 | 0 |
| | | | | 2f: E->N | Polit. | Stra. | 4 | 5 | 0 |
| | | | | | | Tact. | | | |
| | | | | 1F: E->W | Covert TEU | | 26 | | 0 |
| | | | | Covert E->W | | | | | |
| 8 | | 4F + 12f: N | 1F: N | 3F + 12f: N->N | Knowledge | Stra. | 3 | 2 + [4] | |
| Nicole | | | | | | Tact. | 7 | | |
| | | 4S: W | Secret | 4S: W->N | Finance | Stra. | 2 | [3] | |
| | | | | | | Tact. | 9 | 4 + [12 ] | |
| | | | | 2f: N->W | Polit | Stra. | 4 | 5 | |
| | | | | | | Tact. | | | |
| | | | | 1F: N->W | Covert TEU | | 16 | | |
| 9 | | 5P + 2S + 2f: N | | 5P + 2S + 2f: N->N | Knowledge | Stra. | 3 | 4 + [2] | |
| Nicole | | | | | | Tact. | 7 | | |
| | | 4p: W | | 4P: W->N | Finance | Stra. | 2 | 3 | |
| | | | | | | Tact. | 11 | 12 + [2] | |
| | | | | 2f: N->W | Polit. | Stra. | 0 | [9] | |
| | | | | | | Tact. | | | |
| | | | | | Covert TEU | | 16 | | |
| 10 | | 3F + 10f: N | 1F: N | 2F + 5f: N->N | Knowledge | Stra. | 3 | 6 | |
| Nicole | | | | | | Tact. | 7 | | |
| | | 2F: W | Secret | 1F + 3f: N->W | Finance | Stra. | 1 | [4] | |
| | | | | | | Tact. | 16 | 4 + [5] | |
| | | | 3f: N | 2F: W->N | Polit. | Stra. | | 9 | |
| | | | | | | Tact. | | | |
| | | | Secret | 2f: N->W | Covert TEU | | 0 | | |
| 11 | | 6S + 5P: N | | 6S + 5P: N->N | Knowledge | Stra. | 0 | [9] | |
| Nicole | | | | | | Tact. | 0 | [7] | |
| | | 3S + 1F + 7s: W | | 3S + 1F + 7s: W->N | Finance | Stra. | 0 | 4 + [1] | |
| | | | | | | Tact. | 18 | 7 | |
| | | | | 2f: N->W | Polit. | Stra. | | 4 + [5] | |
| | | | | | | Tact. | | | |

Covert TEU

| | | |
|---|---|---|
| 12 | Knowledge | Stra. |
| Werner abandons | | Tact. |
| | Finance | Stra. |
| | | Tact. |
| | Polit. | Stra. |
| | | Tact. |

Covert TEU

Headings: signification of the abbreviations
Rnd Ini: CBT round initiator
Neg Opng: Negotiation Opening
Confront Opng: Confrontation Opening
Def: Defense if appropriate
Outc & Fees: Outcome and fees transferred

093 Let us comment the progression of the CBT, as recorded and Table XII on the previous page, and continuing here above, on this page. Line “0” records on Table XII the assets defined on Table X, and line “1” records the first move where N (Nicole) takes the initiative. The protagonist's first name's initial is recorded in the first column. In the details of this example, the word “asset” designates “asset unit represented by a vignette”.

094 Round 1: Nicole offers 1 Strategic Finance asset (1F: N), in exchange of 1 Strategic Politics asset from Elizabeth (1P: E). After discussion, the negotiation closes with the deal: Nicole transmits 1 Strategic Finance asset to Elizabeth (1F: N→E), receives 1 Strategic Politics asset from Elizabeth (1P: E→N), and transmits 2 Tactical Finance assets to Elizabeth (2f: N→E) resulting from the outcome of the negotiation, which included the transmission of 4 Tactical Finance assets, minus the 2 Tactical Finance assets corresponding to the negotiation interest always due to the original “Finance” protagonists, at the end of a negotiation round.

095 Round 2: Nicole talks quickly, taking the initiative of the round (at the on-set of the CBT, the protagonists have agreed that any protagonist was totally free to take the initiative of a round, regardless of how many rounds he/she may have just lead; this makes a fast and very tense CBT, but quite revealing of true leaders). She decides to confront one of her Strategic Finance assets (1F: N) with one of Werner's Strategic Knowledge asset (1K: W), a move that takes advantage of the superiority of Finance over Knowledge. Werner counteracts by moving an additional Strategic Knowledge asset into the battle (2K: W), but Nicole adds another Strategic Finance asset. Werner could have used the option to throw more into the battle: he could have lined up a total of 5K [according to the rule whereby the attacked possesses, in the considered category, a reserve of assets twice the amount needed to mount the counter-attack], but he didn't, perhaps thinking that Nicole would have faced him with a matching number of Finance assets. As outcome, Nicole, having responded with 2F, keeps her Strategic Finance assets (2F: N→N), but must “freeze” 2 of them (those which just fought the battle) for one round for rest, repair and recovery hence “2+[2]”, in the accounting column. The following round, the “[2]” will be added to the “2” to make up the “4”, of course. Like=wise, the two Strategic Knowledge assets transferred to Nicole from Werner (2K: W ,N), as captured units, will also be frozen for one round: “[2]”. Since this was a confrontation, a levy is due to the original “Politics” protagonist, so Nicole transfers two of her Tactical Finance assets to Elizabeth (2f: N→E).

096 Round 3: Werner attacks, using the superiority of Knowledge over Politics, counteracted by Elizabeth stepping up her defense to 4P, her maximum, because this corresponds to half her existing assets in Politics. But Werner steps up to 4K, so wins the round.

097 Round 4: In this confrontation attempt, Nicole uses all her covert assets: she had placed 2 covert Strategic Politics assets in Elizabeth's camp (table XIb). So, in fact, those assets were hers. Uncovered, they transfer to her camp and she keeps the Strategic Finance assets that Elizabeth was attacking, without having to “freeze” them, as no battle occurred. Elizabeth, the attacker, has to pay the special action covert fee to the holder of Knowledge, this time, as the battle was fought using special attributes (2k: E→W). Elizabeth scores off the 2 assets from her table XIb.

098 Round 5: Apparently in an attempt to build up the availability of small tactical units, essential to pay fees, Elizabeth offers Nicole to swap a Strategic Politics asset unit against 12 Tactical Finance assets. After much bargaining, instead of 12, she gets 7, of which she must pay back 2 as negotiation fee, resulting in 5f: N→E.

099 Round 6: In a broad attack, Nicole musters all the assets needed to take over the remaining Strategic Politics assets which Elizabeth owned, as well as 2 Tactical Finance assets, which remain in Elizabeth's camp, as payment of fees due.

100 Round 7: Elizabeth turns to Werner, trying to negotiate some help in view of her desperate situation, with a swap to recover a Strategic Politics asset which would have twice as much value in her camp than in his. In return, Werner offers her a merge, whereby all Elizabeth's remaining assets are transferred to Werner, including the covert assets, while agreeing with Elizabeth a shared ownership of the assets, and joint management of the new entity, still named “Werner”, for convenience. Now, all the assets of both “Knowledge” and “Politics” category have full value for the new “Werner” merge. The total “covert” value of 26 is calculated from the remaining effective covert capabilities of both Werner and Elizabeth against Nicole. A transaction fee is paid to Nicole (2f: E→N).

101 Rounds 8, 9, 10 and 11: Apparently stimulated by this unexpected “merge” move, Nicole mounts a series of relentless, prompt, but well calculated attacks against Werner, leading her to victory. Note that both Finance and Knowledge fees are now due to Werner. Also note, in row 9, that the attacker, Nicole, uses twice as many units as the attacked, because the assets she uses are not in her specialty (not Finance), hence, in her hands, have half the value they would have had with the original owner. At times, a protagonist can make the CBT very complex and dominate by his/her ability to take promptly advantage of the subtlety of the rules, a characteristic of leaders. The following table XIII reveals how the battle of row 11 is won, as a composite of three sub battles, all fought simultaneously:

TABLE XIII

| | Opposing | | | |
|---|---|---|---|---|
| Protagonists | Assets | Split in 3 sub-battles | | |
| Nicole | 6S + 5P | 6S + 1P | 1P | 3P |
| | | (35 UET) | (5 UET) | (15 UET) |
| Werner | 3S + 1F + 7s | 3S + 1k | 1F | 6s |
| | | (32 UET) | (5 UET) | (12 UET) |

| | | | |
|---|---|---|---|
| Sub-battle outcome | 2 TEU to | Politics | 3 TEU |
| | overcome | dominate | difference |
| | dominance of K | Finance | more than |
| | over P and 1 | | sufficient to |
| | TEU to tip the | | overcome |
| | balance of | | dominance K |
| | equivalence of | | over P |
| | 6K versus 3K | | |

Evaluation of the Leadership Abilities of the Protagonists:

102 Looking at table X, it appears Nicole plans a very active CBT (initiative driven by keeping the upper hand), as she balances her assets with a lot of tactical units, giving the flexibility to pay many fees. By contrast, Elizabeth seems to bank on the stronghold of the highest potential value, by maximizing strategic ones. Werner seems to be tempted by the same approach, but a bit more circumspect.

103 In tables XI, it appears Nicole has spotted Elizabeth's potential weakness in having placed all her assets in a single category. Likewise, Elizabeth has spotted Werner's weakness with his low number of tactical assets, to the point she has taken an oversized provision of covert units in his camp. Is she (unconsciously?) worried about her own weakness in this area?

104 Looking at the progression of the rounds, Nicole turns up as a very strong leader, with her ability to take her turn before any of the other two have the time to do anything; furthermore, her prompt actions are always thought through without mistakes. She evaluates well all the risks, as she knows to execute a safe round when she fears a covert action, while keeping just enough back up for the next rounds. This excellent calculation makes her clearly a Financial leader; she has also the ability to use heavy resources for large confrontations when it is worthwhile, making her a Political leader as well. Her cognitive and meta-cognitive and integrative skills, illustrated especially in round 9, a complex move, are characteristic of a leader. Werner seems to have thoughtful approaches, as in line 3, and is also creative at the right time, with his idea of a merge with Elizabeth, building on a strong balance of assets, which should have overcome Nicole; he turns out to be a true person of Knowledge. However, Werner was not a match against Nicole's stamina and speed. Elizabeth was insecure and, possibly, not fitting the shoes of “Politics”. Her actions were too protective and not aggressive enough to face any of the other two protagonists.

### EXAMPLE 2

### CBT Repeat

105 The CBT is executed again with the same protagonists as in the example (1). Werner sticks with “Knowledge”, Nicole volunteers Politics, and Elizabeth accepts what is left, “Finance”, with a similar distribution of assets for Werner and Nicole as in example (1), and a few tactical units for Elizabeth. This example (2) CBT yields very much the same results as example (1), although no merge occurs. Nicole, who, later, turns against Werner, leaving the later no time to think, confronts Elizabeth early. In fact, the learning from the first example allows Nicole to move even faster. This time, the CBT is over in 9 rounds. The conclusion on the leadership capability of each protagonist is the same as in the previous example.

### EXAMPLE 3

### New CBT, Adding a Protagonist Representing the “Media”

106 Nicole and Werner bring in a new protagonist: Lionel. Elizabeth elects to act the media protagonist. Lionel quickly voices his desire to be “Politics ”, Werner sticks to his usual “Knowledge” role, and Nicole takes the “Finance” role quite happily.

107 Very quickly, Lionel loses the CBT, taking confrontation runs in haste, without sufficient thought given to the balance of strengths. The other protagonists (including the one representing the media) just let him take the initiative of the rounds, after his first mistake. Once Lionel eliminated, Elizabeth, now the media protagonist, creates a lot of confusion by suggesting surprising moves, as her “best guess” of who is going to do what. In fact, in the immediate round which follows Lionel's demise, she “broadcasts” that Nicole might take a broad attack, with many of her strategic units, in effect, slowing Nicole down in her usual promptness, and allowing Werner instead to successfully mount such an attack. Through prompt and enticing negotiations, Nicole re-builds sufficient flexibility in her portfolio to take over the lead and win: she manages to negotiate the transfer of many tactical units, giving her the flexibility to take the lead of several moves, with enough room for fees. In this CBT, Nicole proves again a strong financial leader, Elizabeth as a very influential communicator, and Lionel, as a dreamer.

### EXAMPLE 4

### How a CBT in Team Can be a Substitute to the Election of a Leader

108 The CBT is proposed to a University class of about 270 students, in the process of electing its delegate representative. A team tournament is organized as follows:

109 Each student is requested to join-up with two others, by affinity, or by using whatever criteria they wish, the only requirement being that there must not be any overlapping teams. Teams of four are tolerated towards the end of the process, in case the total number of students of the class does not match a multiple of three. For a class of 270 students, this makes 90 teams. Within each team of three (or four), they are asked to co-opt a leader, using the criteria each team wishes to use. They can, then, forge their “category” ambition, such or such a team having the ambition to be “Finance”, such or such other one having the ambition to be “Knowledge”, etc. The next step is for each team to match up, when possible by consensus, with two other teams, so as to constitute a CBT party. When no consensus is reached, negotiation or simply “no other choice left” should designate the remaining parties. In this way, 30 parties of 3 teams of 3 are ready to execute the CBT. Hence, 30 CBT's are executed simultaneously, each team leader acting as a protagonist of the example I, receiving the advice, encouragement or any other support from each of the two other members of his team. Each team is also free to get organized internally as appropriate, for example, having one member designated to carry out negotiations. At the end of this session, 30 teams are winners, and must delegate one representative each for the next round. The same process as above is repeated: out of 30 new delegates, 9 teams are created, 6 with 3 members and 3 with 4 members, allowing 3 team CBT's to be executed. Delegates from the winners of those three CBT's execute one final CBT.

110 In this way, blending consensus of leadership designation (facilitated by the small size of each team) to achieve a consensus, and leadership visible talent evaluation through only three rounds of CBT's , one can achieve a leadership representation without the formation of a candidate list, avoiding, in this way, what one might consider as an arbitrary step of the democratic process.

### Interest, Practical Application and Discovery Resulting from Practicing the Leadership Evaluation Process in the Form of a Circular CBT

Repeatability and Efficiency of the CBT, a Surprising Aspect to Discover One-Self and the Others: Talents of Interaction, Leadership, Character.

111 By the practice of the Leadership Evaluation Process, one notices its efficiency in revealing, quickly and in broad daylight, one's character, in all its aspects which are critical to leadership: social talents, conciliators, negotiators or aggressive entrepreneurs, capacities to take initiative and make correct and fast decisions as well as strength of character. Cognitive and meta-cognitive and integrative skills become very apparent, especially when the protagonists get involved in highly complex situations, which the CBT provides. Conceived for a serious and investigative purpose concerning circular leadership behaviors, the CBT is most surprising by the degree of discrimination with which it highlights the leadership aspects of anyone's personality; in addition, it turn's up most entertaining for the protagonists. During examples of CBT sessions, quickly, and in a surprising way, such protagonist turned out discovering his/her ambitious behavior well beyond what he/she had anticipated, and this, faster and in a much less stressful way, thus more natural, than during psychometric tests. Such other protagonist, engrossed in the action of the CBT, exploited, by treasures of imagination, unpredictable capacities of negotiation, taking by surprise all the other protagonists. Yet another protagonist got quickly overwhelmed as of the very first round of a CBT, in spite of a highly assertive behavior during its preparation. Another one remained very audacious throughout the CBT. Finally, one turned incapable of follow up after the preparation of the beginning. Examples of CBT sessions also demonstrated high repeatability: re-executed with the same protagonists, they gave very quickly the same revelations concerning each protagonist's personality, even when the actual progression of the CBT turned out different.

112 It is less appropriate to address the reproducibility of the CBT, as defined by comparing the results concerning a given protagonist who executed two different CBT's , with different opponents in each: indeed, although his/her personality quickly stands out, she/he will always be really measured with the varying scale of competition, as in life, i.e. the competitive environment.

113 The surprising efficiency of revelation of character of this CBT makes it a tool of choice for personnel development and recruitment plans for the industrial corporations, as well as in other organizations such as public administration, military planning and universities.

Testing Corporate Situations and Forecasting Possible Evolutions.

114 One can also take advantage of the surprising capabilities of the Leadership Evaluation Process to explore situations of corporations, having hard-to-predict evolution prospects. The CBT process, modeling such situations, will include the implementation of the essential rules of the Leadership Evaluation Process. Specifically, corporate assets will be identified, which can reasonably be modeled by the Leadership Evaluation Process. Human protagonists (protagonists) will be asked to choose which of those categories they want to act out in this simulation. After several CBT sessions, even if it means agreeing a change of role at the beginning of such sessions, one will end up with evolutions that one would not have predicted by the simple didactic reasoning, however sophisticated.

115 Indeed, the CBT integrates the simulation of human imagination in the fire of competitive action, as well as the protagonists' ability to react to it.

116 One shall however make sure that the real situation is a reasonable base that one can simulate with the Leadership Evaluation Process, in particular, that the balance of power in presence at the onset of a CBT session is circular indeed, and that this balance of power can be modified in strength and direction by a quantifiable amount of dominance, which can be brought to bear.

117 One will find such situations in the management of companies and in the evolution of markets within certain political climates. The interested professionals can be universities and business schools, companies, administrations. The Leadership Evaluation Process allows to anticipate situations and reactions of competing powers, with, as only inspiration, the human nature, in the same way as the CBT of a child allows its imagination to anticipate its future world and its reactions, according to its character.

118 In the same way, one can test situations of war or industrial strife (customers: Administration and Military Schools and Universities), or even, stock exchange or other market fluctuation mechanisms, when they meet the modeling criteria of the CBT (e.g. circular dominance).

We claim:

1. A process for evaluating the leadership ability of at least 3 individuals or teams (the “protagonists”) in the form of a behavioral test simulating the non-transitive competitive model of society interaction, where A leads or dominates B, B leads or dominates C and C leads or dominates A, classically referred to as the rock-paper-scissors (RPS) model, said process
causes the protagonists to compete for the ownership of vignettes or similar objects such as playing cards or computer images (the “vignettes”), representing units of assets of at least three categories A, B, C . . . with the help of a sign displayed on each vignette, characteristic of its category, explicitly or conventionally descriptive of a leadership competence and of the non-transitive leadership or dominance relationship it enjoys with respect to the other categories,
provides the means of evaluation of the protagonists as they strive to take the lead of the competition, by keeping a record of their assets' profits and losses and by taking note of their initiative and reactions, and comprises three steps:
step 1, whereby the evaluator, who has the option to delegate this step to the protagonists, defines the leadership competence represented by each category, including the non-transitive dominance relationship between each category, the initial number of vignettes in each category, out of a kit of sufficient quantity of vignettes of all categories to proceed with several rounds of step 3, and sets up the interaction and accounting rules which will govern step 3 so as to calibrate the competition according to the leadership emphasis under scrutiny, particularly the “confrontation differential” which defines how much more asset of a given category is required to reverse the dominance it would otherwise get from an asset of another category,
step 2, whereby the protagonists compete, by argument or as they might agree otherwise, to obtain the attribution of a category of his/her choice so as to collect his/her initial allotment of vignettes, and
step 3, whereby the protagonists display their cognitive, strategic and tactical planning skills and their negotiation and confrontation interactive behavior with each other by swapping vignettes or capturing or destroying them while abiding to the rules set up in step 1, with the objective to collect the maximum amount of assets represented by the vignettes.

2. A process according to claim 1, wherein each category is further divided into two types, whereby any asset represented by a vignette of the first type exerts a dominance over any asset represented by a vignette of the other type, regardless of its category.

3. A process according to claim 1, wherein the categories A, B and C represent the leadership competences of Knowledge-e.g. learned knowledge, know-how, science-Finance-e.g. banking, industry, commerce-and Politics-e.g. government, military-.

4. A process according to claim 3, wherein each category is further divided into two types, representing respectively Strategic competences and Tactical competences, and whereby any asset represented by a vignette of the Strategic type exerts a dominance over any asset represented by a vignette of the the Tactical type, regardless of its category.
